(19) United States
(12) Patent Application Publication
(10) Pub. No.: US 2024/0354565 A1
(43) Pub. Date: Oct. 24, 2024

(54) METHOD FOR GENERATING PERSONALIZED HRTF

(71) Applicant: GIST(Gwangju Institute of Science and Technology), Gwangju (KR)

(72) Inventors: Hong Kook KIM, Gwangju (KR); Geon Woo LEE, Gwangju (KR)

(73) Assignee: GIST(Gwangju Institute of Science and Technology), Gwangju (KR)

(21) Appl. No.: 18/434,417

(22) Filed: Feb. 6, 2024

(30) Foreign Application Priority Data
Apr. 18, 2023 (KR) 10-2023-0051013

(51) Int. Cl. G06N 3/08

(52) U.S. Cl. CPC G06N 3/08

(57) ABSTRACT

The present disclosure relates to a method for generating a personalized HRTF using a neural network model having a one-to-many structure. A method for generating a personalized HRTF according to an embodiment of the present disclosure includes: training a neural network model using multi-angle Head-Related Transfer Functions (HRTF) labeled to body information of a learning object; and obtaining multi-angle HRTFs at a time by inputting body information of a target user into the trained neural network model.

### CROSS REFERENCE TO RELATED APPLICATION

The present application claims priority to Korean Patent Applications No. 10-2023-00-51013, filed Apr. 18, 2023, the entire contents of which are incorporated herein for all purposes by this reference.

### BACKGROUND

### Technical Field

The present disclosure relates to a method for generating a personalized HRTF using a neural network model having a one-to-many structure.

### Description of the Related Art

A Head-Related Transfer Function (HRTF) is a function expressing the path from the position of a sound source to a tympanum of a user as a transfer function.

When such an HRTF is applied to sound, it is possible to provide users with a sense of space such as externalization and positioning, and particularly, when an HRTF is integrated with the technologies of virtual reality and augmented reality, it is possible to provide users with very high spatial immersion.

HRTFs have different characteristics for users due to the differences in body structure of the individuals and are used as equated models rather than personalized models in the related art, so there was a problem that the effect of a sense of space deteriorates.

In order to solve this problem, a method of directly measuring an HRTF for each user has been proposed, but this method has the defect of not only consuming a high cost and a lot of time, but also requiring expensive equipment.

Further, a method of generating an HRTF on the basis of 3D modeling has also been proposed, but this method also has to model the face of each user through computer vision and measure an HRTF in a virtual environment, so there is a defect that the method is complicated and takes a lot of time.

### SUMMARY

An objective of the present disclosure is to generate HRTFs for various angles at a time by inputting body information of a user into a neural network model.

The objectives of the present disclosure are not limited to those described above and other objectives and advantages not stated herein may be understood through the following description and may be clear by embodiments of the present disclosure. Further, it would be easily known that the objectives and advantages of the present disclosure may be achieved by the configurations described in claims and combinations thereof.

In order to achieve the objectives described above, a method for generating a personalized HRTF according to an embodiment of the present disclosure includes: training a neural network model using multi-angle Head-Related Transfer Functions (HRTF) labeled to body information of a learning object; and obtaining multi-angle HRTFs at a time by inputting body information of a target user into the trained neural network model.

In an embodiment, the training of a neural network model includes applying supervised learning to the neural network model by setting the body information of the learning object as input data of the neural network model and setting the multi-angle HRTFs as output data of the neural network model.

In an embodiment, the neural network model includes: at least one fully connected layer extracting features from the body information; and a bidirectional Long Short Term Memory (LSTM) layer receiving the extracted features in a multiple way and outputting preset angle-specific HRTFs.

In an embodiment, the training of a neural network model includes training the neural network model such that the neural network model outputs the multi-angle HRTFs with reference to HRTFs of adjacent angles.

In an embodiment, the neural network model is trained such that a loss function defined as the following [Equation 1] is minimized,

$${ℒ}_{1} ( y , \hat{y} ) = \frac{1}{M} {\sum }_{m = 0}^{M - 1} {\{ {y}_{m} - {\hat{y}}_{m} \}}^{2} \qquad [ Equation 1 ]$$

(where yₘ is a measured HRTF for an m-th angle and ŷₘ is a predicted HRTF for the m-th angle).

In an embodiment, the neural network model is trained such that a loss function defined as the following [Equation 2] is minimized,

$${ℒ}_{2} ( Y , \tilde{Y} ) = \frac{1}{M} {\sum }_{m = 0}^{M - 1} \vert {log}_{10} {Y}_{m} - {log}_{10} {\hat{Y}}_{m} \vert \qquad [ Equation 2 ]$$

(where Yₘ is a measured HRTF at a frequency domain for an m-th angle and Ŷₘ is a predicted HRTF at the frequency domain for the m-th angle).

In an embodiment, the neural network model is trained such that a linear combination of first and second loss functions defined as the following [Equation 1] and [Equation 2], respectively, is minimized,

$${ℒ}_{1} ( y , \hat{y} ) = \frac{1}{M} {\sum }_{m = 0}^{M - 1} {\{ {y}_{m} - {\hat{y}}_{m} \}}^{2} \qquad [ Equation 1 ]$$

$${ℒ}_{2} ( Y , \tilde{Y} ) = \frac{1}{M} {\sum }_{m = 0}^{M - 1} \vert {log}_{10} {Y}_{m} - {log}_{10} {\hat{Y}}_{m} \vert \qquad [ Equation 2 ]$$

(wherein yₘ is a measured HRTF for an m-th angle, ŷₘ is a predicted HRTF for the m-th angle, Yₘ is a measured HRTF at a frequency domain for the m-th angle, and Ŷₘ is a predicted HRTF at the frequency domain for the m-th angle).

In an embodiment, the obtaining of multi-angle HRTFs at a time includes obtaining multi-angle HRTFs at a time by further inputting an ear image of the target user into the neural network model.

The present disclosure generates HRTFs for various angles at a time by inputting body information of a user into a neural network model, thereby being able to greatly reduce the costs and time for generating HRTFs.

Since the present disclosure generates multi-angle HRTFs with reference to HRTFs of adjacent angles, the present disclosure has the advantage that it is possible to reduce standard deviation depending on angles and the stability in prediction of a neural network model is improved.

Detailed effects of the present disclosure in addition to the above effects will be described with the following detailed description for accomplishing the present disclosure.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a flowchart showing a method for generating a personalized HRTF according to an embodiment of the present disclosure;

FIG. 2 is a diagram for explaining an HRTF;

FIG. 3 is a diagram for explaining an HRTF that varies depending on the shape of a user's ear;

FIG. 4 is a diagram showing the case of measuring multi-angle HRTFs for a learning object;

FIG. 5 is a diagram for explaining the operation method of a neural network model;

FIG. 6 is a diagram showing the structure of a neural network model according to an embodiment; and

FIG. 7 is a diagram showing an example of an interface in which the present disclosure has been implemented.

### DETAILED DESCRIPTION

The objects, characteristics, and advantages will be described in detail below with reference to the accompanying drawings, so those skilled in the art may easily achieve the spirit of the present disclosure. However, in describing the present disclosure, detailed descriptions of well-known technologies will be omitted so as not to obscure the description of the present disclosure with unnecessary details. Hereinafter, exemplary embodiments of the present disclosure will be described with reference to accompanying drawings. The same reference numerals are used to indicate the same or similar components in the drawings.

Although terms “first”, “second”, etc. are used to describe various components in the specification, it should be noted that these components are not limited by the terms. These terms are used to discriminate one component from another component and it is apparent that a first component may be a second component unless specifically stated otherwise.

Further, when a certain configuration is disposed “over (or under)” or “on (beneath)” a component in the specification, it may mean not only that the certain configuration is disposed on the top (or bottom) of the component, but that another configuration may be interposed between the component and the certain configuration disposed on (or beneath) the component.

Further, when a certain component is “connected”, “coupled”, or “jointed” to another component in the specification, it should be understood that the components may be directly connected or jointed to each other, but another component may be “interposed” between the components or the components may be “connected”, “coupled”, or “jointed” through another component.

Further, singular forms that are used in this specification are intended to include plural forms unless the context clearly indicates otherwise. In the specification, terms “configured”, “include”, or the like should not be construed as necessarily including several components or several steps described herein, in which some of the components or steps may not be included or additional components or steps may be further included.

Further, the term “A and/or B” stated in the specification means that A, B, or A and B unless specifically stated otherwise, and the term “C to D” means that C or more and D or less unless specifically stated otherwise.

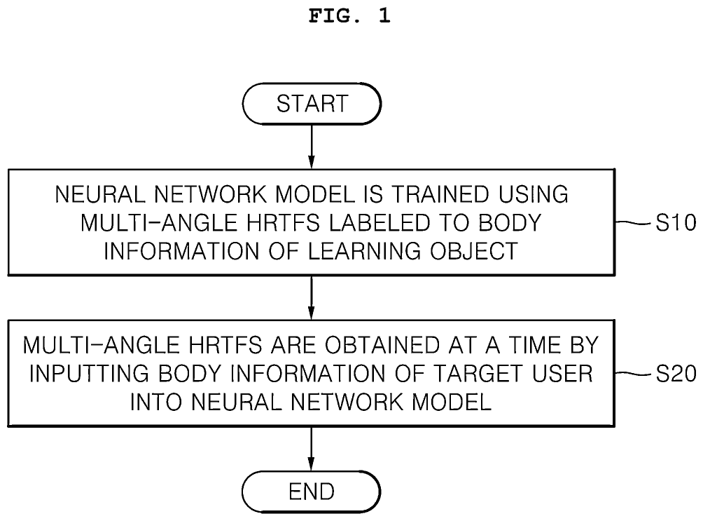

The present disclosure relates to a method for generating a personalized HRTF using a neural network model having a one-to-many structure. Hereafter, a method for generating a personalized HRTF according to an embodiment of the present disclosure is described in detail with reference to FIGS. 1 to 7.

FIG. 1 is a flowchart showing a method for generating a personalized HRTF according to an embodiment of the present disclosure.

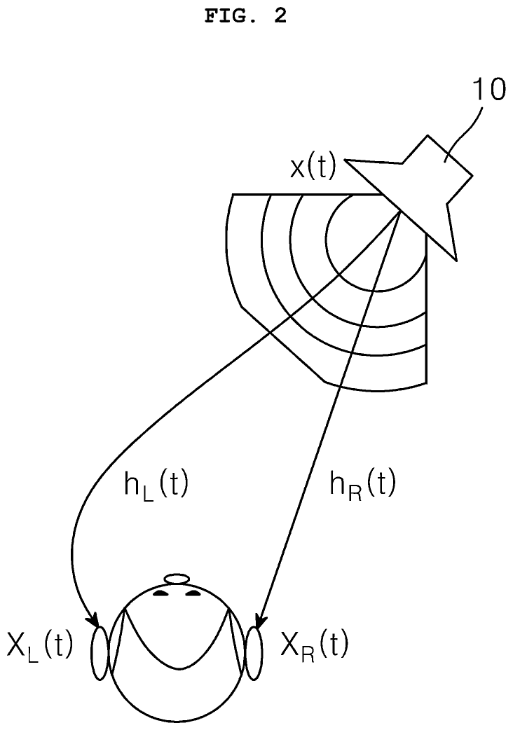

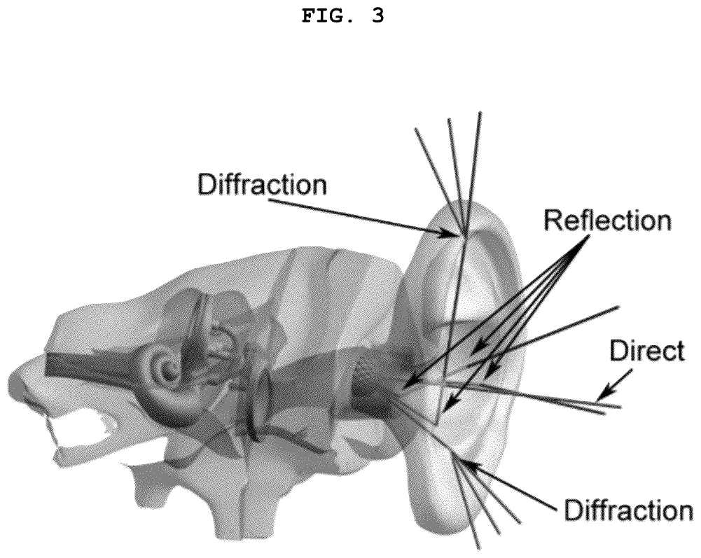

FIG. 2 is a diagram for explaining an HRTF and FIG. 3 is a diagram for explaining an HRTF that varies depending on the shape of a user's ear.

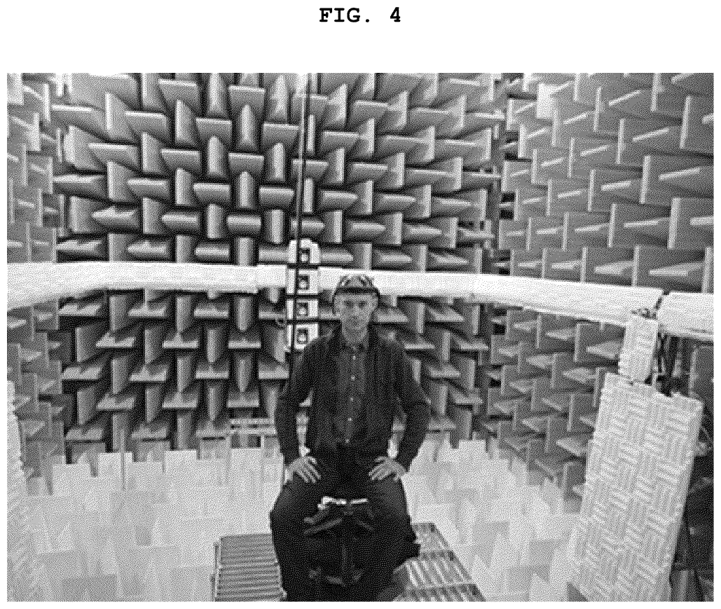

FIG. 4 is a diagram showing the case of measuring multi-angle HRTFs for a learning object.

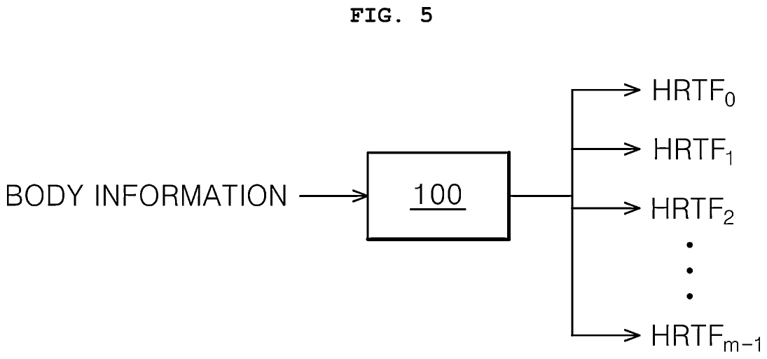

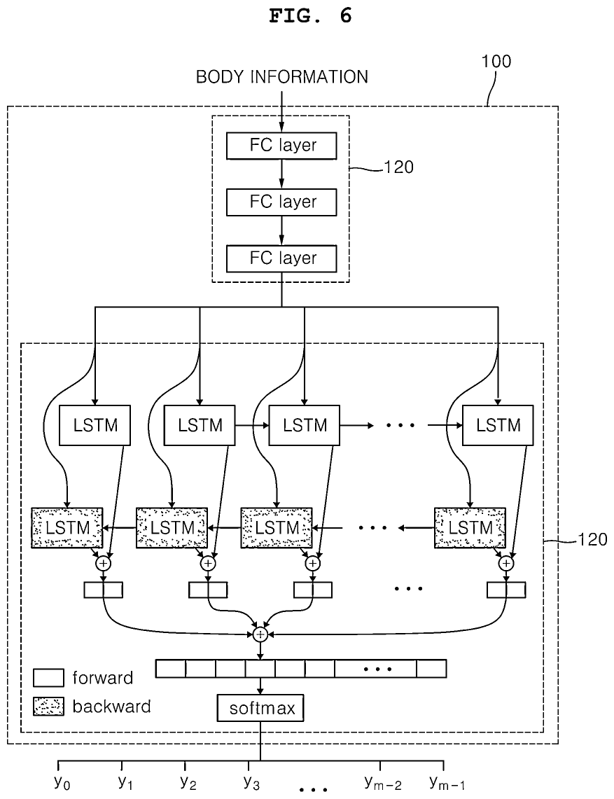

FIG. 5 is a diagram for explaining the operation method of a neural network model and FIG. 6 is a diagram showing the structure of a neural network model according to an embodiment.

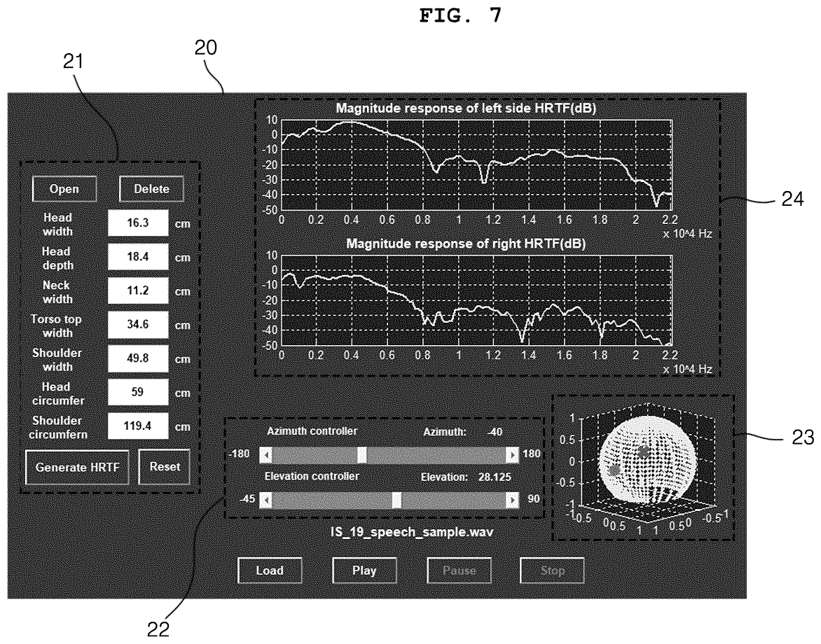

FIG. 7 is a diagram showing an example of an interface in which the present disclosure has been implemented.

Referring to FIG. 1, a method for generating a personalized HRTF according to an embodiment of the present disclosure may include a step of training a neural network model using multi-angle HRTFs labeled to body information of a learning object (S10) and a step of obtaining multi-angle HRTFs at a time by inputting body information of a user into the neural network model (S20).

However, the method for generating a personalized HRTF shown in FIG. 1 is based on an embodiment, the steps of the present disclosure are not limited to the embodiment shown in FIG. 1, and if necessary, some steps may be added, changed, or removed.

Meanwhile, the steps shown in FIG. 1 may be performed by a processor and the processor, in order to perform the individual operations included in each of the steps, may include at least one physical element of application specific integrated circuits (ASICs), digital signal processors (DSPs), digital signal processing devices (DSPDs), programmable logic devices (PLDs), field programmable gate arrays (FPGAs), a controller, and micro-controllers.

First, the process of training the neural network model by means of the processor is described in detail.

The processor can train the neural network model using multi-angle HRTFs labeled to body information of a learning object (S10).

Referring to FIG. 2, an HRTF may be a function that expresses the paths from the position of a sound source 10 to both ears of a user, in detail, both tympanums of the user through transfer functions h_{L}(t) and h_{R}(t). In other words, when an audio output from the sound source 10 is defined as x(t) and audios that are actually sensed at both tympanums of a user are defined as X_{L}(t) and X_{R}(t), an expression showing the relationship between the actually output audio and sensed audios through transfer functions h_{L}(t) and h_{R}(t) may be an HRTF.

Such an HFTF may have different characteristics for users due to the differences in body structure of the individuals. In detail, even though the position of a sound source is the same and the position of a user is the same, an HRTF may vary depending on the shapes of the head, the neck, the torso, or the shoulders of users.

Further, referring to FIG. 3, an audio that is sensed at a tympanum may be defined as a combination of an audio that is directly input to a tympanum of a user and an audio that is reflected and diffracted at the auricle, and the ear shapes of people are different such that they are considered as peculiar bio information, so even though users are the same in the entire external appearance, an HRTF may vary depending on the shapes of the ears.

The present disclosure may use a dataset secured in advance in order to train a neural network model 100 with diversity of HRTFs depending on a body structure described above. In detail, the processor can train the neural network model 100 using multi-angle HRTFs measured and labeled for each learning object.

Referring to FIG. 4, multi-angle HRTFs can be obtained by sensing sounds, which are generated at respective positions, through an earphone or a headset of a learning object. In this case, the multi-angle HRTFs may be obtained for a total of 1250 (25*50) angles of 25 azimuths and 50 elevations.

In this case, body information of the learning object and the multi-angle HRTFs corresponding thereto are matched to each other, whereby they can be constructed into a dataset. In this case, the body information may include at least one of a head width, a head depth, a neck width, a torso top width, a shoulder width, a head circumference, and a shoulder circumference, and may further include even an ear image.

The dataset constructed in this way may be stored in an external server or a database and the processor can receive the dataset from the external server or the database and train the neural network model 100.

In detail, the processor can set the body information of the learning object and the multi-angle HRTFs matched to the body information as a training dataset and can apply supervised learning to the neural network model 100.

Referring to FIG. 5, the processor can set body information of many learning objects as input data of the neural network model 100 and can set multi-angle HRTFs matched to the body information as output data of the neural network model 100.

Accordingly, the neural network model 100 can learn the correlation between the body information and the multi-angle HRTFs according to the body information. In detail, parameters (weight and bias) of each of layers constituting the neural network model 100 may be updated to receive body information for learning and output multi-angle HRTFs corresponding to the body information.

Referring to FIG. 6, in an example, the neural network model 100 may include at least one fully connected layer 110 that extracts features from body information and a bidirectional Long Short Term Memory (LSTM) layer 120 that receives the extracted features in a multiple way and outputs preset angle-specific HRTFs.

The processor can set body information of many learning objects as input data of the fully connected layer 110 and can set multi-angle HRTFs corresponding to the body information as output data of the bidirectional LSTM layer 120.

The fully connected layer 110 can extract features by reducing the dimension of body information including at least one of a head width, a head depth, a neck width, a torso top width, a shoulder width, a head circumference, and a shoulder circumference. The features extracted from the fully connected layer 110 can be duplicated and input into the bidirectional LSTM layer 120.

The bidirectional LSTM layer 120 can extract hidden values of the features, which are extracted from the fully connected layer 110, forward and backward through sequentially connected cells. Hidden values extracted from the forward and backward cells respectively can be concatenated and applied to a softmax function and the bidirectional LSTM layer 120 can output multi-angle HRTFs corresponding to the body information previously input into the fully connected layer 110.

In this case, since the body information that is input into the fully connected layer 110 and the multi-angle HRTFs that are output from the bidirectional LSTM layer 120 are set in advance as a training dataset, the parameters of the fully connected layer 110 and the bidirectional LSTM layer 120 can be updated to receive body information and output multi-angle HRTFs corresponding to the body information.

Meanwhile, the processor can train the neural network model 100 to output multi-angle HRTFs with reference to HRTFs of adjacent angles.

As described above with reference to FIG. 2, since an HRTF is a function that expresses the paths from the position of a sound source to both ears of a user through transfer functions, the similarity of HRTFs for sound sources at adjacent angles may be high. In order to improve prediction performance of the neural network model 100, the processor may make the neural network model 100 refer to adjacent HRTFs as metadata when outputting HRTFs for specific angles.

In detail, the processor can define a loss function of the neural network model 100 as the following [Equation 1] and can train the neural network model 100 such that the loss function is minimized.

$${ℒ}_{1} ( y , \hat{y} ) = \frac{1}{M} {\sum }_{m = 0}^{M - 1} {\{ {y}_{m} - {\hat{y}}_{m} \}}^{2} \qquad [ Equation 1 ]$$

(where yₘ is a measured HRTF for an m-th angle and ŷₘ is a predicted HRTF for the m-th angle).

As described by exemplifying FIG. 6, since the neural network model 100 of the present disclosure has a structure that predicts multi-angle HRTFs at a time, an HRTF error for each angle can be applied to the loss function of the neural network model 100. Further, since the loss function is defined as [Equation 1], the neural network model 100 can be trained in consideration of even errors for other adjacent angles.

Meanwhile, it has been known in acoustics that a frequency response shows a large difference, depending on listeners, and in the present disclosure, it is possible to make the neural network model 100 refer to adjacent HRTFs as metadata when outputting HRTFs for specific angles at a frequency domain in order to generate more personalized HRTFs.

In detail, the processor can define a loss function of the neural network model 100 as the following [Equation 2] and can train the neural network model 100 such that the loss function is minimized.

$${ℒ}_{2} ( Y , \tilde{Y} ) = \frac{1}{M} {\sum }_{m = 0}^{M - 1} \vert {log}_{10} {Y}_{m} - {log}_{10} {\hat{Y}}_{m} \vert \qquad [ Equation 2 ]$$

(where Yₘ is a measured HRTF at a frequency domain for an m-th angle and Ŷₘ is a predicted HRTF at the frequency domain for the m-th angle).

As described by exemplifying FIG. 6, since the neural network model 100 of the present disclosure has a structure that predicts multi-angle HRTFs at a time, angle-specific HRTF errors generated at a frequency domain can be applied to the loss function of the neural network model 100. Further, since the loss function is defined as [Equation 2], the neural network model 100 can be trained in consideration of a frequency response.

The processor can also train the neural network model 100 using both of the two loss functions described above. In detail, the processor can train the neural network model 100 such that a linear combination of first and second loss functions defined as [Equation 1] and [Equation 2], respectively, is minimized.

That is, the processor can train the neural network model 100 such that a final loss function defined as the following [Equation 3] is minimized.

$${ℒ}_{f} = {ℒ}_{1} + λ {ℒ}_{2} \qquad [ Equation 3 ]$$

where λ is a hyperparameter and can be determined as an appropriate value by a user on the basis of the predicted performance of the neural network model 100 computed in a validation step of the neural network model 100.

As described above, since the present disclosure generates multi-angle HRTFs with reference to HRTFs of adjacent angles, the present disclosure has the advantage that it is possible to reduce standard deviation depending on angles and the stability in prediction of the neural network model 100 is improved.

When supervised learning is finished in accordance with the method described above, the neural network model 100 can receive body information that was not used for learning and can output predicted multi-angle HRTFs corresponding thereto.

Next, a process of generating a personalized HRTF of a target user using the neural network model 100 by means of the processor is described in detail.

The processor can obtain multi-angle HRTFs at a time by inputting body information of a target user into the trained neural network model 100 (S20).

The processor can obtain body information of a target user through a user terminal and input the obtained body information into the neural network model 100 that has been trained. Since the neural network model 100 has already learned the correlation between body information and multi-angle HRTFs, it is possible to receive body information of a target user and output predicted values of angle-specific HRTFs at a time.

Meanwhile, when an ear image of a learning object is used as input data in the learning step S10, the processor can further obtain an ear image of a target user and can input the ear image into the neural network model 100 together with body information. Since the neural network model 100 has already learned the correlation between ear images, body information, and multi-angle HRTFs, it is possible to receive the ear image and body information of a target user and output predicted values of angle-specific HRTFs at a time.

Referring to FIG. 7, the present disclosure can be implemented as software or an application and can output an interface 20 through a user terminal. The interface 20 may be composed of a body information input tab 21, an angle adjustment tab 22, a 3D position output tab 23, and an HRTF output tab 24.

A target user can input his/her head width, head depth, neck width, torso top width, shoulder width, head circumference, and shoulder circumference through the body information input tab 21, and though not shown in the figures, can additionally input an ear image.

The processor can obtain multi-angle HRTFs at a time by inputting the input body information into the neural network model 100 and can output the multi-angle HRTFs through the HRTF output tab 24. In detail, a target user can adjust the azimuth and elevation of a sound source through the angle adjustment tab 22 and the adjusted position of the sound source can be visualized through the 3D position output tab 23.

Meanwhile, when an azimuth and an elevation are determined, the processor can recognize the HRFT corresponding to the angles and can output HRTFs for both ears into a graph type through the HRTF output tab 24.

As described above, the present disclosure generates HRTFs for various angles at a time by inputting body information of a user into the neural network model 100, thereby being able to greatly reduce the costs and time for generating HRTFs.

Although the present disclosure was described with reference to the exemplary drawings, it is apparent that the present disclosure is not limited to the embodiments and drawings in the specification and may be modified in various ways by those skilled in the art within the range of the spirit of the present disclosure. Further, even though the operation effects according to the configuration of the present disclosure were not clearly described with the above description of embodiments of the present disclosure, it is apparent that effects that can be expected from the configuration should be also admitted.

What is claimed is:

1. A method for generating a personalized HRTF, the method comprising:
Training, by processor, a neural network model using multi-angle Head-Related Transfer Functions (HRTF) labeled to body information of a learning object by means of a processor; and
obtaining, by processor, multi-angle HRTFs at a time by inputting body information of a target user into the trained neural network model by means of the processor.

2. The method of claim 1, wherein the training of a neural network model includes applying supervised learning to the neural network model by setting the body information of the learning object as input data of the neural network model and setting the multi-angle HRTFs as output data of the neural network model.

3. The method of claim 1, wherein the neural network model includes:
at least one fully connected layer extracting features from the body information; and
a bidirectional Long Short Term Memory (LSTM) layer receiving the extracted features in a multiple way and outputting preset angle-specific HRTFs.

4. The method of claim 1, wherein the training of a neural network model includes training the neural network model such that the neural network model outputs the multi-angle HRTFs with reference to HRTFs of adjacent angles.

5. The method of claim 1, wherein the neural network model is trained such that a loss function defined as the following [Equation 1] is minimized,
$${ℒ}_{1} ( y , \hat{y} ) = \frac{1}{M} {\sum }_{m = 0}^{M - 1} {\{ {y}_{m} - {\hat{y}}_{m} \}}^{2} \qquad [ Equation 1 ]$$
(where yₘ is a measured HRTF for an m-th angle and ŷₘ is a predicted HRTF for the m-th angle).

6. The method of claim 1, wherein the neural network model is trained such that a loss function defined as the following [Equation 2] is minimized,
$${ℒ}_{2} ( Y , \tilde{Y} ) = \frac{1}{M} {\sum }_{m = 0}^{M - 1} \vert {log}_{10} {Y}_{m} - {log}_{10} {\hat{Y}}_{m} \vert \qquad [ Equation 2 ]$$
(where Yₘ is a measured HRTF at a frequency domain for an m-th angle and Ŷₘ is a predicted HRTF at the frequency domain for the m-th angle).

7. The method of claim 1, wherein the neural network model is trained such that a linear combination of first and second loss functions defined as the following [Equation 1] and [Equation 2], respectively, is minimized,
$${ℒ}_{1} ( y , \hat{y} ) = \frac{1}{M} {\sum }_{m = 0}^{M - 1} {\{ {y}_{m} - {\hat{y}}_{m} \}}^{2} \qquad [ Equation 1 ]$$
$${ℒ}_{2} ( Y , \tilde{Y} ) = \frac{1}{M} {\sum }_{m = 0}^{M - 1} \vert {log}_{10} {Y}_{m} - {log}_{10} {\hat{Y}}_{m} \vert \qquad [ Equation 2 ]$$
(wherein yₘ is a measured HRTF for an m-th angle, ŷₘ is a predicted HRTF for the m-th angle, Yₘ is a measured HRTF at a frequency domain for the m-th angle, and Ŷₘ m is a predicted HRTF at the frequency domain for the m-th angle).

8. The method of claim 1, wherein the obtaining of multi-angle HRTFs at a time includes obtaining multi-angle HRTFs at a time by further inputting an ear image of the target user into the neural network model.
